(19) United States
(12) Patent Application Publication
(10) Pub. No.: US 2012/0120874 A1
(43) Pub. Date: May 17, 2012

(54) WIRELESS ACCESS POINT CLOCK SYNCHRONIZATION SYSTEM

(75) Inventors: Michael McLaughlin, Dublin (IE); Billy Verso, Maynooth (IE)

(73) Assignee: DecaWave Limited, Dublin (IE)

(21) Appl. No.: 13/296,711

(22) Filed: Nov. 15, 2011

Related U.S. Application Data
(60) Provisional application No. 61/413,545, filed on Nov. 15, 2010.
(60) Provisional application No. 61/415,175, filed on Nov. 18, 2010.

(51) Int. Cl. H04W 56/00; H04W 88/08

(52) U.S. Cl. 370/328

(57) ABSTRACT

In an ultra-wideband (“UWB”) network, a central location engine (“CLE”) coordinates operation of an anchor access point (“AP”), AP[0], and a plurality of non-anchor AP[x]s. A clock calibration packet (“CCP”) transmission method and related apparatus facilitate normalization of CCP time references reported to the CLE by all APs. Implementing a digital phase locked loop (“DPLL”) in the CLE facilitates clock normalization. Implementing a DPLL in at least the non-anchor AP[x]s facilitates local clock synchronization, and may improve network efficiency by reducing clock synchronization traffic.

### BACKGROUND OF THE INVENTION

1. Field of the Invention

The present invention relates generally to wireless access point systems, and, in particular, to clock synchronization in a wireless access point system.

2. Description of the Related Art

In general, in the descriptions that follow, we will italicize the first occurrence of each special term of art which should be familiar to those skilled in the art of ultra-wideband (“UWB”) communication systems. In addition, when we first introduce a term that we believe to be new or that we will use in a context that we believe to be new, we will bold the term and provide the definition that we intend to apply to that term. In addition, throughout this description, we will sometimes use the terms assert and negate when referring to the rendering of a signal, signal flag, status bit, or similar apparatus into its logically true or logically false state, respectively, and the term toggle to indicate the logical inversion of a signal from one logical state to the other. Alternatively, we may refer to the mutually exclusive boolean states as logic_{—}0 and logic_{—}1. Of course, as is well known, consistent system operation can be obtained by reversing the logic sense of all such signals, such that signals described herein as logically true become logically false and vice versa. Furthermore, it is of no relevance in such systems which specific voltage levels are selected to represent each of the logic states.

In general, in an ultra-wideband (“UWB”) communication system, a series of special processing steps are performed by a UWB transmitter to prepare payload data for transmission via a packet-based UWB channel. Upon reception, a corresponding series of reversing steps are performed by a UWB receiver to recover the data payload. Details of both series of processing steps are fully described in IEEE Standards 802.15.4 (“802.15.4”) and 802.15.4a (“802.15.4a”), copies of which are submitted herewith and which are expressly incorporated herein in their entirety by reference.

One of us, Michael McLaughlin, has developed certain improvements for use in UWB communication systems, which improvements are fully described in the following pending applications or issued patents, all of which are expressly incorporated herein in their entirety:
“A Method and Apparatus for Generating Codewords”, U.S. Pat. No. 7,787,544, issued 31 Jul. 2010;
“A Method and Apparatus for Generating Codewords”, application Ser. No. 11/309,222, filed 13 Jul. 2006, now abandoned;
“A Method and Apparatus for Transmitting and Receiving Convolutionally Coded Data”, U.S. Pat. No. 7,636,397, issued 22 Dec. 2009;
“A Method and Apparatus for Transmitting and Receiving Convolutionally Coded Data”, application Ser. No. 12/590,124, filed 3 Nov. 2009; and
“A Receiver for Use in an Ultra-Wideband Communication System”, application Ser. No. 12/885,517, filed 19 Sep. 2010, now PCT Application PCT/US11/52056, filed 17 Sep. 2011.

In general, a network of UWB access points (APs) may be employed to locate mobile tags using the known time difference of arrival method. However, the precision of this method is dependent on careful synchronization of the AP clocks. Although various techniques for clock synchronization are known, all of which we are aware suffer from one or more disadvantages. For example, it is possible to achieve clock synchronization using wired distribution of a master clock signal to each AP; but such an implementation is relatively expensive to install and relatively difficult thereafter to modify the physical configuration of the APs. Accordingly, a method and related apparatus for synchronization of all network clock timebases using only wireless transmissions is desirable.

We submit that what is needed is an improved wireless clock synchronization method and apparatus for use in a UWB communication system. In particular, we submit that such a method and apparatus should provide performance generally comparable to the best prior art techniques but without the disadvantages of known implementations of such prior art techniques.

### BRIEF SUMMARY OF THE INVENTION

In accordance with a first embodiment of our invention, we provide a clock synchronization method and apparatus for use in an ultra-wideband (UWB) communication network. In general, the network comprises a plurality of access points, APs, including a first access point, AP[0], having a first timebase, and a second access point, AP[1], having a second timebase; and a central location engine, CLE. According to our invention, the CLE is adapted to store a time of flight, ToF[0:1], between AP[0] and AP[1]. AP[0] is adapted to develop and transmit a clock synchronization packet, CCP, to AP[1] at a selected time of transmission, ToT. AP[1] is adapted to receive the CCP and, in response, to develop and transmit an AP response packet, ARP[1], to AP[0], the ARP[1] having embedded therein a time of arrival, ToA[1], referenced to the second timebase. AP[0] is further adapted to receive the ARP[1] and, in response, to develop and transmit a clock response packet, CRP1, to the CLE, the CRP[1] having embedded therein the ToA[1]. The CLE is adapted to receive the CRP[1] and, in response, to calculate a skew between the first and second timebases as a function of the ToT, the ToA[1] and the ToF[0:1].

In accordance with a second embodiment of our invention, AP[1] is adapted to receive the CCP and, in response, to develop and transmit the clock response packet, CRP[1], directly to the CLE, the CRP[1] having embedded therein the time of arrival, ToA[1], referenced to the second timebase.

In accordance with a third embodiment of our invention, AP[0] is adapted to develop the clock synchronization packet, CCP, for transmission at a selected time of transmission, ToT, and to embed the ToT in the transmitted CCP. Further, AP[1] is adapted to receive the CCP at a time of arrival, ToA[0:1::1], referenced to the second timebase, and, in response, to develop a second time of arrival, ToA[0:1::0], referenced to the first timebase as a function of the ToT, the ToA[0:1::1] and the ToF[0:1].

In accordance with a fourth embodiment of our invention, we provide an access point, AP, for use in a wireless communication network, wherein the AP is adapted to develop a selected time of transmission, ToT; and thereafter start transmission of a clock synchronization packet, CCP, such that a selected portion of the CCP is transmitted at precisely the selected ToT. In this embodiment, the AP implements our method for developing a selected time of transmission, ToT, and for thereafter starting transmission of a clock synchronization packet, CCP, such that a selected portion of the CCP is transmitted at precisely the selected ToT.

In accordance with a fifth embodiment of our invention, we provide an access point, AP, for use in a wireless communication network, wherein the AP is adapted to transmit a clock synchronization packet, CCP, and then record the precise time of transmission, ToT, referenced to the AP's timebase, of a selected portion of the CCP. In this embodiment, the AP implements our method for transmitting the CCP, and then recording the ToT of the selected portion of the CCP.

We submit that each of these embodiments of our invention achieve clock synchronization as effectively as any prior art method or apparatus now known to us, but without the associated disadvantages.

### BRIEF DESCRIPTION OF THE SEVERAL VIEWS OF THE DRAWINGS

Our invention may be more fully understood by a description of certain preferred embodiments in conjunction with the attached drawings in which:

FIG. 1 illustrates, in topological form, a UWB communication network comprising a plurality of APs;

FIG. 2 illustrates, in time-distance form, the network of FIG. 1;

FIG. 3 illustrates, in parallel flow diagram form, operation of a local portion of the network of FIG. 1;

FIG. 4 illustrates, in parallel flow diagram form, operation of a remote portion of the network of FIG. 1;

FIG. 5 illustrates, in parallel flow diagram form, operation of a second embodiment of the network of FIG. 1;

FIG. 6 illustrates, in time flow diagram form, details of a portion of the flow diagram of FIG. 5;

FIG. 7 illustrates, in logic diagram form, a digital phase locked loop (DPLL) adapted for use in the network of FIG. 1; and

FIG. 8 illustrates, in logic diagram form, a digital clock normalizer adapted for use in association with the DPLL in FIG. 7.

In the drawings, similar elements will be similarly numbered whenever possible. However, this practice is simply for convenience of reference and to avoid unnecessary proliferation of numbers, and is not intended to imply or suggest that our invention requires identity in either function or structure in the several embodiments.

### DETAILED DESCRIPTION OF THE INVENTION

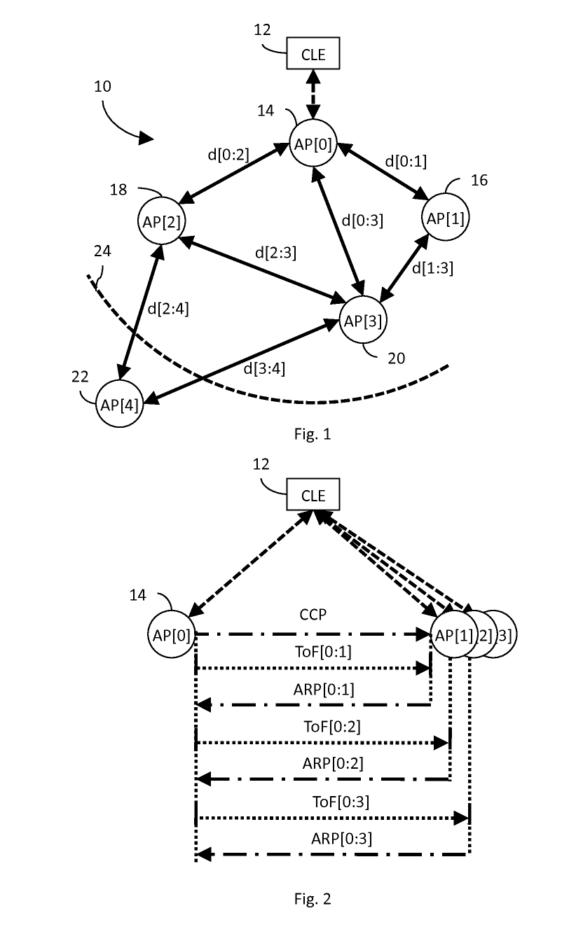

Shown in FIG. 1 is a UWB network 10 comprising a central location engine (CLE) 12 and a plurality of APs: AP[0] 14; AP[1] 16; AP[2] 18; AP[3] 20; and AP[4] 22; each AP generally comprising a conventional UWB transmitter, receiver and associated control (all not shown for clarity). In the illustrated topology, the physical distance, d, between each pair of APs is depicted as a bi-directional arrow connecting the AP pair, and labeled with the respective distance, d[x:y], where x indicates the first AP of the pair and y indicates the second AP of the pair. By way of illustration, we have shown AP[1-3] as all being within the effective transmission range of AP[0], indicated by dashed arc 24, whereas AP[4] is outside that range and thus must be accessed via either AP[2] or AP[3].

In network 10, a primary responsibility of the CLE 12 is to synchronize the timebases of all APs so as to assure normalized time references with respect to mobile tag-related reports. As is known, the topological distance, d[x:y], between each pair of APs can be used to calculate the theoretical time of flight (ToF[x:y]) of a radio frequency signal between the APs; alternatively, the actual ToF[x:y] can be determined empirically by measurement in the field. In accordance with one embodiment of our invention, our method and related apparatus facilitates periodic transmission to the CLE of timebase reports from all APs, which then can be normalized by the CLE as a function of the respective pre-calculated and stored times of flight, ToF[x:y]. In accordance with one other embodiment of our invention, each non-anchor AP is specially adapted to synchronize the local timebase to the timebase of the anchor AP[0], such that all network time reference reports transmitted to the CLE 12, including both synchronization-related and normal tag-related reports, are inherently normalized.

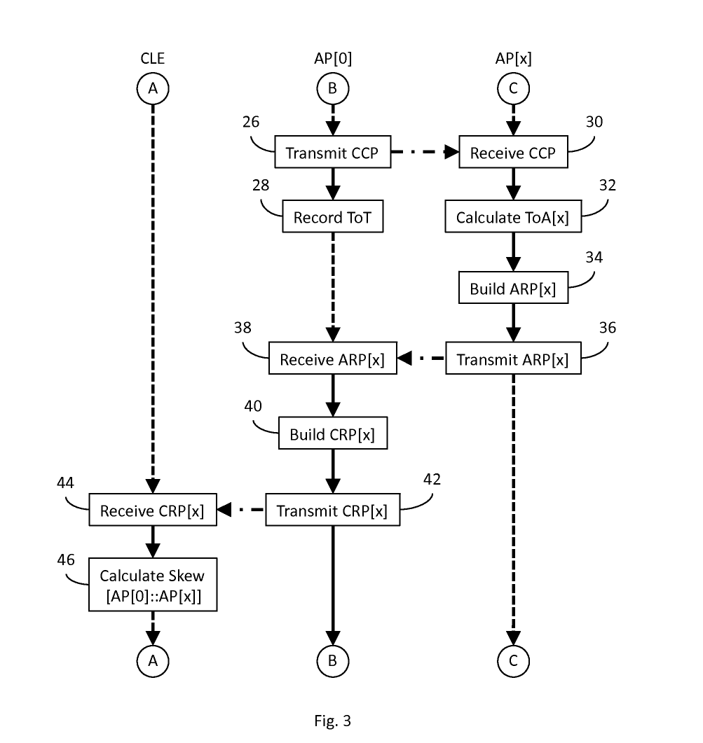

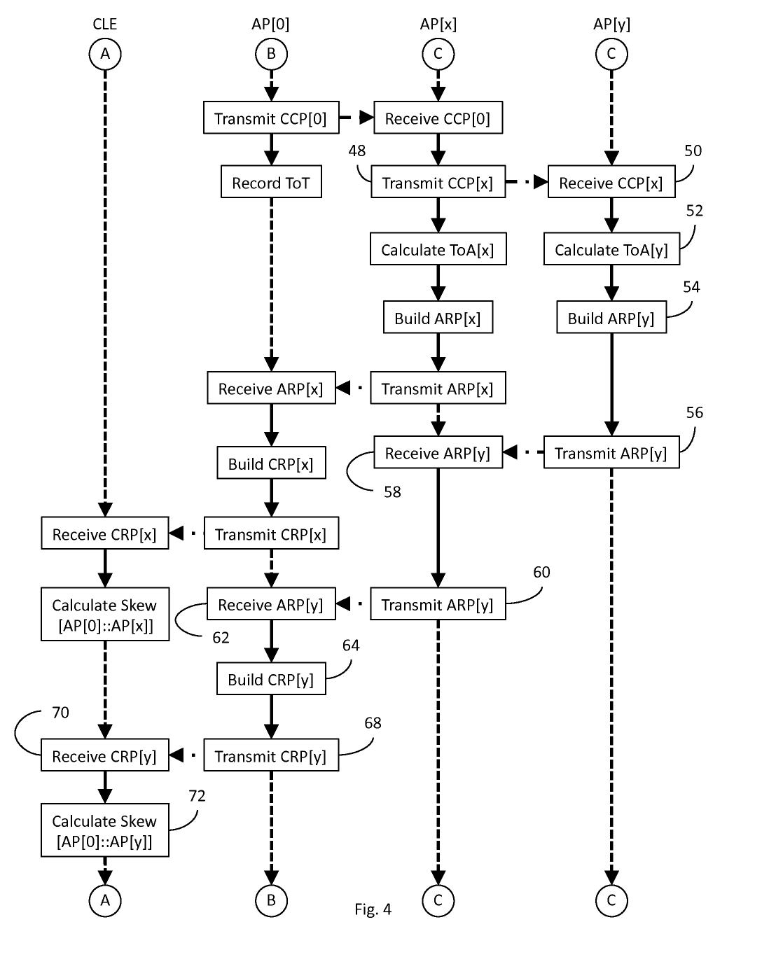

As shown in both FIG. 1 and FIG. 2, AP[0] is selectively configured by CLE 12 as the network anchor, thus requiring all time (and distance) references to be calculated with respect to the AP[0] clock (position). In accordance with a first embodiment of our invention, illustrated in FIG. 3, AP[0] is adapted periodically to develop and transmit a multi-bit clock calibration packet (CCP) (step 26), and then to record the actual time of transmission (ToT) of the CCP, with respect to the AP[0] clock (step 28). Upon receipt (step 30), each receiving AP[x] will calculate the time of arrival (ToA) of the CCP from AP[0], ToA[x], with respect to the AP[x] clock (step 32). (Note: for convenience of reference, we here have employed x as a shorthand summary for our full construct “0:x::x”, wherein: the first numeral indicates the transmitting AP, in this case AP[0]; the x following the single colon indicating the receiving AP, generically referred to as AP[x]; and the x following the double colon indicating the respective time base, in this case the timebase of the local AP, namely AP[x].) ToA[x] may now be used to develop (step 34) and transmit a respective AP response packet (ARP[x]) (step 36). Upon receipt (step 38), AP[0] will develop (step 40) and transmit to the CLE 12 a respective clock response packet (CRP[x]) having embedded therein both the ToT[0] and the ToA[x] (step 42). From the known, fixed distances d between each of the APs, CLE 12 can calculate actual ToA[0] (i.e., with respect to the AP[0] clock) of the CCP by each of the non-anchor APs (step 44), and thereafter use the difference, or skew, between the reported ToA[x] and actual ToA[0] to normalize time references returned by the respective AP[x] to the AP[0] clock (step 46). So long as this clock calibration process is performed sufficiently frequently, CLE 12 will be able effectively to track drift between the several AP clocks. In general, the desired frequency of CCPs is a function of the short term stability of the clock oscillators in the various APs.

By way of illustration, let us posit that AP[1]'s clock is 1% faster than AP[0]'s clock, and we want to adjust AP[1]'s reported CCP arrival time references to AP[0]'s timebase. Assume for this example that a packet is sent by AP[0] every 200 clock counts. Say a CCP arrives at AP[1] at count 504 by AP[1]'s clock, but the CLE 12 calculates (from known physical network distances) that it arrived when AP[0]'s clock was 100. Now the CLE knows that a count of 504 in AP[1]'s timebase is equivalent to 100 in AP[0]'s timebase. So, 200 AP[0] counts later another packet arrives at AP[1]. From AP[0]'s sending report the CLE calculates it will arrive at count 300 by AP[0]'s clock. Because AP[1]'s timebase is 1% faster, it reports an arrival time of 706. Now the CLE knows that a count of 706 in AP[1]'s timebase is equivalent to 300 in AP[0]'s timebase. The CLE can now normalize any tag arrival reports from AP[1] with a count of anywhere between 504 and 706 by linear interpolation: e.g., a count of 605 from AP[1] is equivalent to 200 in AP[0]'s timebase. Now, if a tag report arrives from AP[1] with a count higher than 706, the CLE can either wait for another CCP report from AP[1] and interpolate as before, or extrapolate using previous CCP data: e.g., a tag report of 807 would be converted to 400. Note that although the above normalization approach adjusts relative receive time references, transmit time references could equally be used for synchronization, wherein CCP send time references may be calculated by subtracting ToF from receive time references, rather than receive time references being calculated from send time references by adding ToF. We recognize, however, that rather than our proposed simple interpolation, other more sophisticated, well known interpolation methods may be used. For example, we might consider using the following:

$$ToA [ tag : 1 :: 0 ] = ToF [ 0 : 1 ] + {ToT [ 0 : 1 :: 0 ]}_{i - 1} + \frac{\begin{matrix}( ToA [ tag : 1 :: 1 ] - {ToA [ 0 : 1 :: 1 ]}_{i - 1} ) * \\ ( {ToT [ 0 : 1 :: 0 ]}_{i} - {ToT [ 0 : 1 :: 0 ]}_{i - 1} )\end{matrix}}{( {ToA [ 0 : 1 :: 1 ]}_{i} - {ToA [ 0 : 1 :: 1 ]}_{i - 1} )} \qquad [ Eq . 1 ]$$

where: [tag:x::y] denotes that the ToA is for a message (sometimes referred to as a ‘blink’) from the tag received by AP[x] and converted to the AP[y]'s timebase.

In one alternate embodiment, each AP may report independently to the CLE 12 using, e.g., wireline. In either embodiment, however, the CLE 12 will be able to maintain normalization factors for all APs in the network 10, thereby enabling precise location of all mobile tags being monitored by the network 10.

As shown in FIG. 4 (in which only new steps are enumerated), our invention can be easily adapted to include APs that are outside the effective transmission range 24 of the anchor AP[0]. In this embodiment, CLE 12 can designate a selected non-anchor AP[x] to transmit, in response to receiving the original CCP[0], a new CCP[x] to a more remote AP[y] (step 48). Upon receipt (step 50), AP[y] will calculate the ToA[y] of the CCP[x] from AP[x], with respect to the AP[y] clock (step 52). The resulting ToA[y] will then be used to develop (step 54) and transmit a respective ARP[y]) (step 56). Upon receipt (step 58), AP[x] will relay the ARP[y] to the AP[0] (step 60). Upon receipt (step 62), AP[0] will develop (step 64) and transmit to the CLE 12 a respective CRP[y] having embedded therein both the ToT[0] and the ToA[y] (step 68). From the known, fixed distances d between each of the APs, CLE 12 can calculate actual ToA of the CCP[x] reported by each of the remote APs (step 70), and thereafter use the frequency offset, or skew, between the reported and actual ToA to normalize time references returned by the respective AP to the AP[0] clock (step 72).

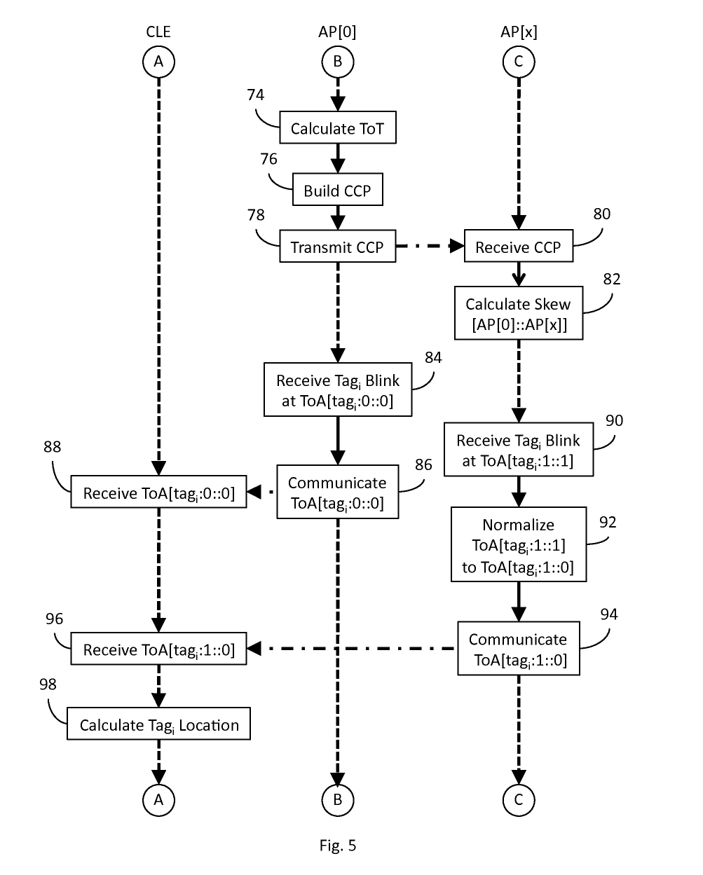

In the alternate embodiment shown in FIG. 5, all non-anchor APs are adapted to report directly to the CLE 12 in response to receiving a CCP from anchor AP[0], thereby relieving AP[0] of the task of developing and relaying the various CRP. In this embodiment, AP[0] is adapted in accordance with a further one of our inventions (to be disclosed in detail below) to develop, in advance of actual transmission of the CCP, the anticipated ToT (step 74), and to embed that ToT in a selected position in the CCP (step 76) prior to transmission (step 78). Upon receipt (step 80), each receiving AP[x] is further adapted in accordance with yet another of our inventions (also to be disclosed in detail below) to calculate the skew, [AP[0]::AP[x]], between the local AP[x] clock and the AP[0] clock (step 82). In one embodiment, to be discussed below, AP[1] may use the calculated skew to synchronize the local clock to the AP[0] clock.

Continuing now with routine network operation, AP[0] receives a blink from tag, at a time of arrival, ToA[tagᵢ:0::0], referenced to the first timebase (step 84), and, since the ToA[tagᵢ:0::0] is already referenced to the first timebase, proceeds to communicate to the CLE 12 the ToA[tagᵢ:0::0] (steps 86 and 88). Some small time interval later, due to different topological positions of the APs, AP[1] now receives the same blink from tag, but at a time of arrival, ToA[tagᵢ:1::1], referenced to the second timebase (step 90). Using the known skew between the first and second timebases, AP[1] can locally normalize the ToA[tagᵢ:1::1] to a time of arrival, ToA[tagᵢ:1::0], referenced to the first timebase (step 92), and then communicate the normalized ToA[tagᵢ:1::0] to the CLE (steps 94 and 96). Later, in response to receiving a sufficient number of ToAs for the same blink from tagᵢ, e.g., at least four (4), the CLE may calculate the topological location of tag, as a function of the known location of AP[1] and the set of all ToAs for the same blink from tag, (step 98).

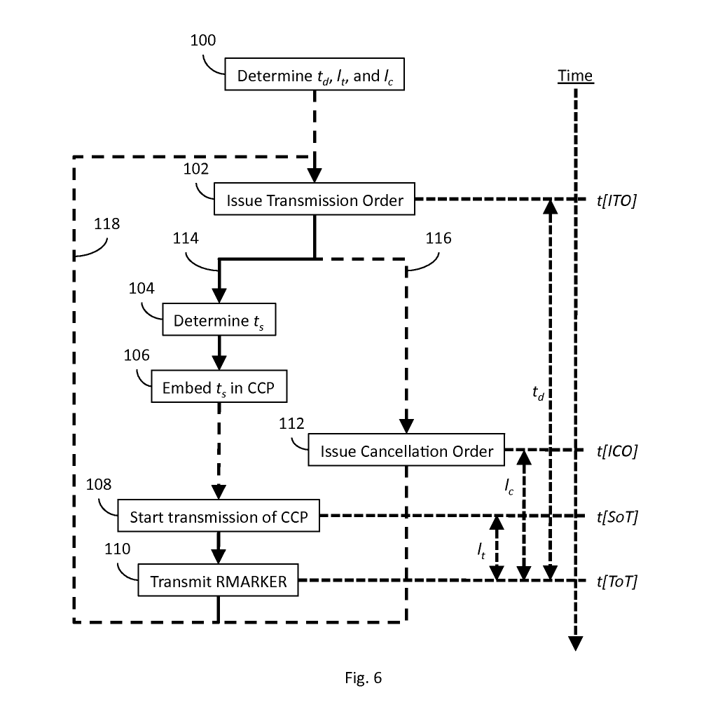

As noted above, AP[0] may be adapted dynamically to predict the actual ToT of each CCP. The IEEE 802.15.4a standard nominates a specific part of the frame, i.e., the first pulse of the PHY Header, as the RMARKER. Therefore, let us designate the precise time that the RMARKER in the CCP message leaves AP[0]'s antenna (not shown but necessarily present) as the send time of that CCP. We propose the following approach, illustrated in FIG. 6:

1. Determine the time delay, t_{d}, between the time that a transmission order is issued, (t[ITO]), and the actual time of transmission of the first bit of the RMARKER at AP[0]'s antenna, (t[ToT]) (step 100):

t_{d}=t[ITO]−t[ToT] [Eq.2]

This delay can be determined by calculation during design or measured during operation, and, preferably, both. Preferably, this delay is periodically recalibrated.

2. At time a selected t[ITO], issue a transmission order to AP[0] to transmit a CCP (step 102).

3. Calculate the projected send time, tₛ, of the RMARKER (step 104):

tₛ=t_{y}+t_{d} [Eq.3]

4. Embed the calculated, multi-bit send time in the RMARKER field of the ordered CCP (step 106).

5. Start transmission of the CCP (step 108).

6. Transmit the RMARKER (step 110).

Now, because of other system activity, it may happen that AP[0] will be unable to achieve transmission of an ordered CCP message at the projected send time. Accordingly, it is desirable to cancel the pending CCP message so as to prevent transmission of the CCP message with a stale send time as follows:

1. Predetermine (by calculation or measurement), the transmitter latency, lₜ, between start of transmission of the CCP frame, t[SoT], and the time of transmission of the first bit of the embedded RMARKER, t[ToT] (a first enhancement of step 100).

2. Predetermine (by calculation or measurement), the cancellation latency, l_{c}, being the minimum time between issuance of a cancellation order, t[ICO], and successful cancellation of a pending transmission order (a second enhancement of step 100).

3. Issue the cancellation order if transmission has not been initiated at or before time t[ICO] (step 112).

In FIG. 6, after step 102, control flow effectively forks into parallel, independent threads, with the left thread 114 representing the normal control flow, and the right thread 116 representing the exception control flow. For clarity, we have depicted flow of time via an annotated vector extending vertically along the right side of FIG. 6. During operation, if CCP transmission actually starts before the calculated t[ICO], thread 114 will retain control and complete CCP transmission; otherwise, thread 116 will assert control and cancel CCP transmission. We have indicated (via dashed feedback path 118) that the illustrated process will normally be recursive, operating periodically according to a desired schedule.

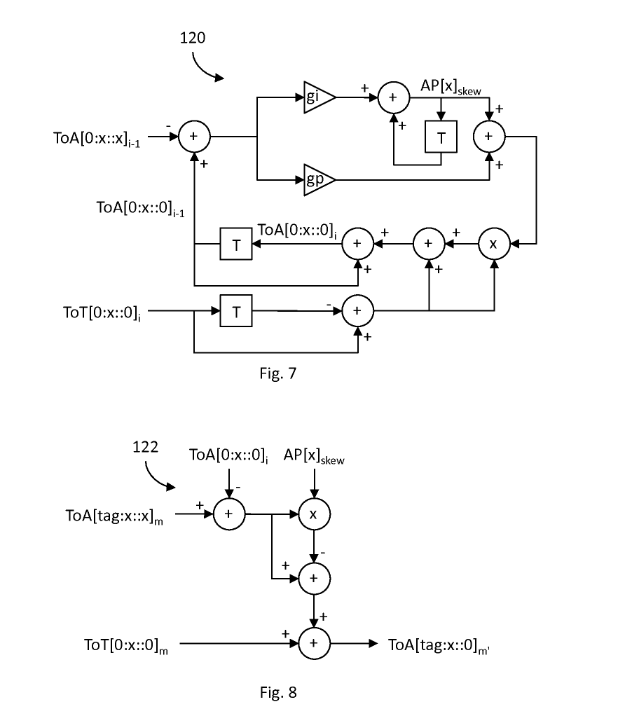

As shown in FIG. 7, CLE 12 may be adapted to normalize ToA reports from all non-anchor AP[x]s with respect to the reported ToT[0] using a digital phase locked loop (DPLL) 120, or other preferred form of Kalman filter. In FIG. 7, the input AP[x]ᵢ₋₁ comprises AP[x]'s reported ToA of CCP[i−1], and the input AP[0]ᵢ comprises AP[0]'s reported ToT of CCP[i] plus the calculated ToF of CCP[i] from AP[0] to AP[x], i.e., the actual ToA of CCP[i] at AP[x] as normalized to AP[0] clock. Following is a pseudocode instantiation of our proposed DPLL:

```
[Pcode 1] function ap1Err = clocktrack
  nReports = 1000;
  interval = 1000e−3; % 100ms between CCPs
  errorStd = 0.3e−9; % 0.3 ns error std
  ppm = 20; % crystal offset
  gp = 0.1; % proportional arm
  gi = 0.01; % integral arm;
  ap0Reports = [0 cumsum(interval/2+interval *
    (rand(1,nReports)−0.5))];
  ap1Reports = 10 * interval + ap0Reports * (1+ppm/1e6);
  ap1Est = zeros(size(ap1Reports)); % initial estimate
  ap1Err = ap1Est;
  intArm = ap1Est;
  ap1FreqOffsetEst = ap1Est;% initial skew
  offsetPhase = ap1Est;
  ap0Diff = [diff(ap0Reports) interval];
  % now add some errors
  ap1Reports = ap1Reports + randn(size(ap1Reports)) *
      errorStd;
  % initialize 1st ToA estimate of 1st report
  ap1Est(1) = ap1Reports(1);
  % initialize intArm to first estimate of skew
  intArm(1) = (ap1Reports(2)−ap1Reports(1))/ap0Diff(1)−1;
  % now operate DPLL over nReports
  for (iReport = 2:nReports−1)
  {
    ap1Err(iReport−1) = (ap1Reports(iReport−1) −
      ap1Est(iReport−1))/interval;
    intArm(iReport) = gi * ap1Err(iReport−1) +
      intArm(iReport−1);
    ap1FreqOffsetEst(iReport) = gp * ap1Err(iReport−1) +
      intArm(iReport); % calculate new skew
    offsetPhase(iReport) = ap0Diff(iReport−1) *
      ap1FreqOffsetEst(iReport);
    ap1Est(iReport) = ap1Est(iReport−1) + ap0Diff(iReport−1) +
      offsetPhase(iReport); % calculate new ToA estimate
  }
end
```

If desired, the CLE 12 may employ known figure of merit (FoM) or other known statistical methods to identify and disregard rogue CCP ToA reports. In the alternative, the CLE 12 may selectively weight the error term used by our DPLL 120.

Having determined the skew between the AP[0] clock and the AP[x] clock, we propose to use a clock normalizer 122, such as that shown in FIG. 8, to normalize, with respect to the current AP[0]ₘ, subsequently reported time references AP[x]ₘ associated, for example, with mobile tags. In this embodiment, our CCP transmission method and related apparatus will facilitate normalization of CCP-related time references reported to the CLE by all APs, and, when used in combination, our clock normalization method and related apparatus will facilitate normalization by the CLE of tag-related time references reported by all APs.

Building now on the capability of AP[0] to embed in each CCP the actual ToT, we propose to implement in at least each non-anchor AP[x] a DPLL 120 adapted to synchronize the local AP[x] clock to the AP[0] clock. In this embodiment, each AP[x] is now capable of locally normalizing all time references with respect to the AP[0] clock, including mobile tag-related reports, thereby relieving the CLE 12 of the need to normalize received time references. Of course, it may still be desirable for other reasons to have each of the APs report to the CLE 12 selected operating parameters of the local DPLL 120.

In accordance with yet another embodiment, AP[0] may wait until a first CCP[0]ᵢ has been successfully transmitted, record the precise time, t[ToT]ᵢ, that the RMARKER is transmitted, and then embed the recorded t[ToT]ᵢ in the next CCP[0]ᵢ₊₁. Using this method, the embedded t[ToT]ᵢ is determined a posteriori and is, therefore, always assured to be precise.

Thus it is apparent that we have provided an improved wireless clock synchronization method and apparatus for use in a UWB communication system. In particular, we submit that our method and apparatus provides performance generally comparable to the best prior art techniques but without the disadvantages of known implementations of such prior art techniques. Therefore, we intend that our invention encompass all such variations and modifications as fall within the scope of the appended claims.

What we claim is:

1. Apparatus for use in an ultra-wideband (UWB) communication network, the network comprising:
a plurality of access points, APs, comprising a first access point, AP[0], having a first timebase, and a second access point, AP[1], having a second timebase; and
a central location engine, CLE;
wherein:
the CLE is adapted to store a first time of flight, ToF[0:1], between AP[0] and AP[1];
AP[0] is adapted to develop and transmit a first clock synchronization packet, CCP[0], to AP[1] at a first selected time of transmission, ToT[0];
AP[1] is adapted to receive the CCP[0] and, in response, to develop and transmit a first AP response packet, ARP[1], to AP[0], the ARP[1] having embedded therein a first time of arrival, ToA[1], referenced to the second timebase;
AP[0] is further adapted to receive the ARP[1] and, in response, to develop and transmit a first clock response packet, CRP[1], to the CLE, the CRP[1] having embedded therein the ToA[1]; and
the CLE is adapted to receive the CRP[1] and, in response, to calculate a first skew between the first and second timebases as a function of the ToT, the ToA[1] and the ToF[0:1].

2. The apparatus of claim 1 wherein the ToF[0:1] is determined empirically by measurement.

3. The apparatus of claim 1 wherein the ToF[0:1] is calculate as a function of a topological distance between AP[0] and AP[1].

4. The apparatus of claim 1 wherein AP[0] periodically transmits the CCP[0].

5. The apparatus of claim 1 further comprising a third access point, AP[2], having a third timebase, wherein:
the CLE is adapted to store a second time of flight, ToF[1:2], between AP[1] and AP[2];
AP[1] is further adapted selectively to transmit a second CCP[1] to AP[2] at a second selected time of transmission, ToT[1];
AP[2] is adapted to receive the transmitted CCP[1] and, in response, to develop and transmit a second ARP[2] to AP[1], the ARP[2] having embedded therein a second time of arrival, ToA[2], referenced to the third timebase;
AP[1] is further adapted selectively to retransmit the ARP[2] to AP[0];
AP[0] is further adapted to receive the ARP[2] and, in response, to develop and transmit a second clock response packet, CRP[2], to the CLE, the CRP[2] having embedded therein the ToA[2]; and
the CLE is adapted to receive the CRP[2] and, in response, to calculate a second skew between the first and third timebases as a function of the ToT[1], the ToA[2] and the ToF[1:2].

6. Apparatus for use in an ultra-wideband (UWB) communication network, the network comprising:
a plurality of access points, APs, comprising a first access point, AP[0], having a first timebase, and a second access point, AP[1], having a second timebase; and
a central location engine, CLE;
wherein:
the CLE is adapted to store a first time of flight, ToF[0:1], between AP[0] and AP[1];
AP[0] is adapted to develop and transmit a clock synchronization packet, CCP, to AP[1] at a selected time of transmission, ToT;
AP[1] is adapted to receive the CCP and, in response, to develop and transmit a first clock response packet, CRP[1], to the CLE, the CRP[1] having embedded therein a first time of arrival, ToA[1], referenced to the second timebase; and
the CLE is adapted to receive the CRP[1] and, in response, to calculate a first skew between the first and second timebases as a function of the ToT, the ToA[1] and the ToF[0:1].

7. The apparatus of claim 6 wherein the ToF[0:1] is determined empirically by measurement.

8. The apparatus of claim 6 wherein the ToF[0:1] is calculated as a function of a topological distance between AP[0] and AP[1].

9. The apparatus of claim 6 wherein the CLE develops a time of arrival, ToA[0:1::0], referenced to the first timebase, from the ToA[0:1::1] using a digital phase locked loop.

10. The apparatus of claim 6 wherein the CLE develops a time of arrival, ToA[0:1::0], referenced to the first timebase, from the ToA[0:1::1] using linear interpolation.

11. The apparatus of claim 6 wherein AP[1] is further adapted selectively to develop and transmit to the CLE a first tag report packet having embedded therein a first tag time reference, ToA[tag:1::1], referenced to the second timebase.

12. The apparatus of claim 11 wherein the CLE develops a time of arrival, ToA[tag:1::0], referenced to the first timebase, from the ToA[tag:1::1] using a digital phase locked loop and a normalizer.

13. The apparatus of claim 11 wherein the CLE develops a time of arrival, ToA[tag:1::0], referenced to the first timebase, from the ToA[tag:1::1] using linear interpolation.

14. The apparatus of claim 6 wherein AP[0] periodically transmits the CCP.

15. The apparatus of claim 6 further comprising a third access point, AP[2], having a third timebase, wherein:
the CLE is adapted to store a second time of flight, ToF[1:2], between AP[1] and AP[2];
AP[1] is further adapted selectively to transmit a second CCP[1] to AP[2] at a second selected time of transmission, ToT[1];
AP[2] is adapted to receive the transmitted CCP[1] and, in response, to develop and transmit a second clock response packet, CRP[2], to the CLE, the CRP[2] having embedded therein a second time of arrival, ToA[2], referenced to the third timebase; and
the CLE is adapted to receive the CRP[2] and, in response, to calculate a second skew between the first and third timebases as a function of the ToT[1], the ToA[2] and the ToF[1:2].

16. Apparatus for use in an ultra-wideband (UWB) communication network, the network comprising a plurality of access points, APs, comprising a first access point, AP[0], having a first timebase, and a second access point, AP[1], having a second timebase, wherein:
AP[0] is adapted to develop a clock synchronization packet, CCP, for transmission at a selected time of transmission, ToT, the ToT being embedded in the CCP, and to transmit the CCP to AP[1] at the selected ToT; and
AP[1] is adapted to receive the CCP at a first time of arrival, ToA[0:1::1], referenced to the second timebase, and, in response, to develop a second time of arrival, ToA[0:1::0], referenced to the first timebase as a function of the ToT, the ToA[0:1::1] and a first predetermined time of flight, ToF[0:1], between AP[0] and AP[1].

17. The apparatus of claim 16 wherein the ToF[0:1] is determined empirically by measurement.

18. The apparatus of claim 16 wherein the ToF[0:1] is calculated as a function of a topological distance between AP[1] and AP[0].

19. The apparatus of claim 16 wherein AP[1] develops the ToA[0:1::0] from the ToA[0:1::1] using a digital phase locked loop.

20. The apparatus of claim 16 wherein AP[1] is further adapted to:
receive a tag blink having a third time of arrival, ToA[tag:1::1], referenced to the second timebase; and
develop and transmit a first tag report packet having embedded therein a fourth time of arrival, ToA[tag:1::0], referenced to the first timebase.

21. The apparatus of claim 20 wherein AP[1] develops the ToA[tag:1::0] from the ToA[tag:1::1] using a digital phase locked loop and a normalizer.

22. The apparatus of claim 20 wherein AP[1] develops the ToA[tag:1::0] from the ToA[tag:1::1] using linear interpolation.

23. The apparatus of claim 16 wherein AP[0] periodically transmits the CCP.

24. The apparatus of claim 16 wherein the network further comprises a central location engine, CLE, and wherein:
AP[0] is further adapted to transmit to the CLE the ToT; and
AP[1] is further adapted to transmit to the CLE the ToA[0:1::0].

25. The apparatus of claim 24 wherein the CLE is further adapted to store the ToT and ToA[0:1::0].

26. The apparatus of claim 16 further comprising a third access point, AP[2], having a third timebase, wherein:
AP[1] is further adapted selectively to retransmit the CCP to AP[2]; and
AP[2] is adapted to receive the CCP at a first time of arrival, ToA[2], referenced to the third timebase, and, in response, to develop a second time of arrival, ToA[2], referenced to the first timebase as a function of the ToT, the ToA[2] and a first predetermined time of flight, ToF[0:2], between AP[0] and AP[2].

27. The apparatus of claim 26 wherein AP[2] is further adapted selectively to develop and transmit a second tag report packet having embedded therein a second tag time reference referenced to the first timebase.

28. An access point (AP) for use in a wireless communication network, wherein the AP is adapted to:
develop a selected time of transmission, ToT; and
start transmission of a clock synchronization packet, CCP, such that a selected portion of the CCP is transmitted at precisely the selected ToT.

29. The AP of claim 28 further adapted to:
develop a cancellation latency, l_{c}, as a function of the ToT; and
cancel transmission of the CCP if transmission thereof has not started as of l_{c} before the ToT.

30. A method for use in a wireless communication network, the method comprising the steps of:
developing a selected time of transmission, ToT; and
starting transmission of a clock synchronization packet, CCP, such that a selected portion of the CCP is transmitted at precisely the selected ToT.

31. The method of claim 30 further comprising the steps of:
developing a cancellation latency, l_{c}, as a function of the ToT; and
cancelling transmission of the CCP if transmission thereof has not started as of l_{c} before the ToT.

32. A first access point, AP[0], for use in a wireless communication network, wherein AP[0] is adapted to:
transmit a first clock synchronization packet, CCP[0]; and
record a first time of transmission, ToT[0], referenced to a first timebase, of a selected portion of the CCP[0].

33. The apparatus of claim 32 wherein AP[0] is further adapted to:
transmit a second clock synchronization packet, CCP[1], having embedded therein the recorded ToT[0].

34. The apparatus of claim 33 further comprising a second access point, AP[1], adapted to:
receive the CCP[0] at a first time of arrival, ToA[0:1::1]₁, referenced to a second timebase;
receive the CCP[1] at a second time of arrival, ToA[0:1::1]₂, referenced to the second timebase; and
develop a third time of arrival, ToA[0:1::0]₁, referenced to the first timebase, as a function of ToA[0:1::1]₁ and ToT[0].

35. A method for use in a wireless communication network, the method comprising the steps of:
in a first access point, AP[0]:
transmitting a first clock synchronization packet, CCP[0]; and
recording a first time of transmission, ToT[0], of a selected portion of the CCP.

36. The method of claim 35 further comprising the step of:
transmitting a second clock synchronization packet, CCP[1], having embedded therein the recorded ToT[0].

37. The method of claim 36 further comprising a second access point, AP[1], further comprising the steps of:
in a second access point, AP[1]:
receiving the CCP[0] at a first time of arrival, ToA[0:1::1]₁, referenced to a second timebase;
receiving the CCP[1] at a second time of arrival, ToA[0:1::1]₂, referenced to the second timebase; and
developing a third time of arrival, ToA[0:1::0]₁, referenced to the first timebase, as a function of ToA[0:1::1]₁ and ToT[0].
